(19) United States
(12) Patent Application Publication
(10) Pub. No.: US 2007/0291720 A1
(43) Pub. Date: Dec. 20, 2007

(54) APPARATUS AND METHOD FOR TRANSMITTING CHANNEL QUALITY INDICATORS IN A MOBILE COMMUNICATION SYSTEM

(76) Inventor: Young Jo LEE, Gunpo-si (KR)

Correspondence Address: KED & ASSOCIATES, LLP, P.O. Box 221200, Chantilly, VA, 20153-1200, US

(21) Appl. No.: 11/764,947

(22) Filed: Jun. 19, 2007

(30) Foreign Application Priority Data
Jun. 20, 2006 (KR) 10-2006-0055383

(51) Int. Cl. H04Q 7/24; H04Q 7/20

(52) U.S. Cl. 370/338; 455/450

(57) ABSTRACT

There is provided a method for transmitting one or more CQIs between a mobile station and a base station in a mobile communication system. The method may include: identifying a channel condition between the mobile station and the base station; adjusting a number of CQIs to be transmitted in accordance with the channel condition; and transmitting the adjusted number of CQIs from the mobile station to the base station.

The present application claims priority from Korean Patent Application No. 10-2006-55383 filed on Jun. 20, 2006, the entire subject matter of which is incorporated herein by reference.

### BACKGROUND

1. Field

The present invention generally relates to a communication system, and more particularly to an apparatus and method for transmitting channel quality indicators (CQIs) between a mobile station and a base station.

2. Background

Generally, a mobile communication system can always call or connect to a partner wirelessly through switching control of a mobile switching center (MSC) or packet data connection control of a packet data serving node (PDSN), while a user of a mobile station moves within a service area formed by a base station. Recently, due to technological developments in mobile communications, it is possible to perform data or multimedia communication (in addition to communication using audio signals) through a mobile communication system. As a result, there was a significant need for a high-speed wireless data service. In response to such a need, new types of mobile communication systems such as EV-DO (Evolution Data Only) and HSDPA (High Speed Downlink Packet Access) have been developed and commercialized.

In these systems, AMC (Adaptive Modulation and Coding) is adopted as a link adaptation technique to efficiently use wireless links. AMC is a link adaptation technique that is efficient for transferring multimedia data, wherein a transfer rate is changed according to channel environments. In order to provide a high speed data service using the AMC technique, it is necessary to identify a channel condition between a mobile station and a base station. For such identification, channel quality indicators (CQIs) are transmitted from the mobile station to the base station in order to notify the receive channel condition of the mobile station. That is, when the condition of the channel, through which the mobile station receives data, is notified as an index or a CQI from the mobile station to the base station, the base station identifies the receive channel condition of the mobile station and transfers data in a data rate suitable for the channel condition. For example, as for the mobile station with a channel condition represented as a good CQI value, the base station transfers data at a relatively high rate (e.g., 2.4 Mbps) to the mobile station. On the contrary, as for the mobile station with a channel condition represented as a poor CQI value, the base station transfers data at a relatively low rate (e.g., 38.4 kbps) to the mobile station.

Since massive data such as video data are commonly used in the recent days, there are many cases wherein the data rate of EV-DO or HDSPA is not sufficient. Accordingly, there was a need for a data service having a higher transfer rate. In order to meet such needs, the techniques using a wider range of frequency bandwidth were suggested. That is, as for EV-DO, while a frequency bandwidth of 1.25 MHz is used in a basic EV-DO, a system called NxEV-DO that binds multiple 1.25 MHz bandwidths for use with obtaining a higher data rate is under development. For example, when three 1.25 MHz bandwidths are bound to form 3xEV-DO, it is possible to obtain a greater than three times higher data rate.

Further, as for mobile internet systems using wide frequency bandwidths (e.g., MHz, 10 MHz, 20 MHz, etc.), certain techniques were provided that divide such wide frequency bandwidths into sub-bandwidths using OFDM (Orthogonal Frequency Division Multiplexing) technique.

Meanwhile, as the mobile communication systems use wider frequency bandwidths, there occurred a problem related to variation in channel characteristics within a frequency bandwidth. That is, when measuring channel characteristics used at some time, it is unstable since there is a different fading in a different frequency. Conventional CQI transmission methods ignored this point and transmitted a single CQI from a mobile station to a base station, assuming that characteristics of whole frequency bandwidths in use are uniform. This method was not a problem when a narrow bandwidth was used. However, as bandwidths grow wider, a CQI cannot reflect the channel condition. As a result, there was a problem in that the data rate in which the base station transfers data cannot reflect the channel condition accurately.

As a method to resolve this problem, there needed a solution to divide a wide bandwidth into multiple sub-bandwidths and individually identify the condition of each sub-bandwidth to transmit corresponding CQIs. For example, it is possible to divide a bandwidth into sixteen sub-bandwidths and calculate a CQI indicating the condition of each sub-bandwidth to generate sixteen CQIs in sum. By way of transmitting these sixteen CQIs from a mobile station to a base station, it is possible to reflect variations among channel characteristics occurring in a wide bandwidth to data transfer rates.

However, the above solution was defective. First, since a mobile station should transmit sixteen CQIs to a base station, sixteen times more data should be transmitted compared to a single CQI being transmitted. This results in interference with other mobile stations using the same base station. Thus, the overall capability of the base station is reduced. Further, when the transmission power of the mobile station is not sufficient or the channel environments between the mobile station and the base station are poor, there may be a problem in that the base station may misread the CQI transmitted from the mobile station.

Accordingly, it is necessary to reduce the amount of interference when transmitting CQIs in a mobile communication system. It is also necessary to reduce the error rate when detecting CQIs in a base station in a mobile communication system.

### BRIEF DESCRIPTION OF THE DRAWINGS

Arrangements and embodiments may be described in detail with reference to the following drawings in which like reference numerals refer to like elements and wherein:

FIG. 1 illustrates a scheme for an exemplary mobile communication system where the present invention may be implemented.

FIG. 2 illustrates a scheme for a mobile station and a base station in accordance with one embodiment of the present invention.

FIGS. 3A and 3B are diagrams illustrating a CQI transmission number controller, a CQI calculator and a communication unit in accordance with a first embodiment of the present invention.

FIG. 4 is a diagram illustrating a CQI transmission number controller, a CQI calculator and a communication unit in accordance with a second embodiment of the present invention.

FIG. 5 illustrates a scheme for a mobile station and a base station in accordance with another embodiment of the present invention.

FIG. 6 is a flow chart illustrating the procedures to determine the change of CQI transmission numbers in a mobile station in accordance with one embodiment of the present invention.

FIG. 7 is a flow chart illustrating the procedures to determine the change of CQI transmission numbers in a base station in accordance with another embodiment of the present invention.

### DETAILED DESCRIPTION OF THE PRESENT INVENTION

A detailed description may be provided with reference to the accompanying drawings. One of ordinary skill in the art may realize that the following description is illustrative only and is not in any way limiting. Other embodiments of the present invention may readily suggest themselves to such skilled persons having the benefit of this disclosure.

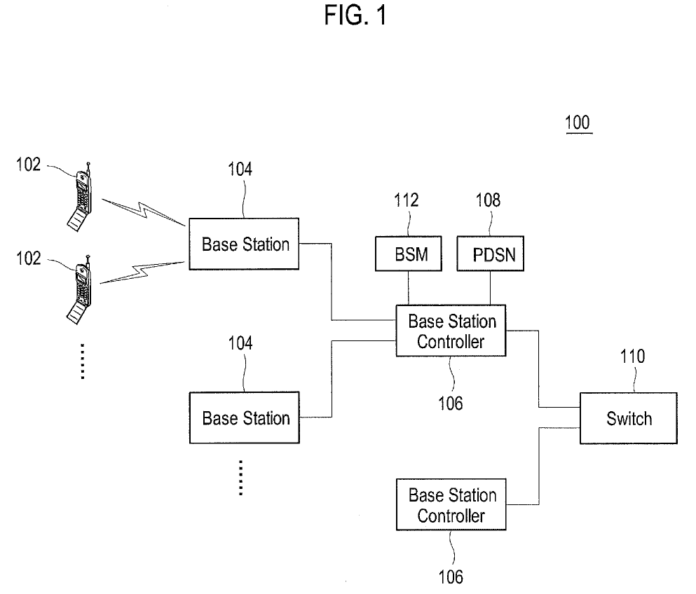

FIG. 1 illustrates a scheme for an exemplary mobile communication system where the present invention may be implemented. As shown in FIG. 1, the mobile communication system 100 comprises a plurality of mobile stations 102, a plurality of base stations 104 wirelessly connected to the mobile stations 102, a base station controller (BSC) 106 to control the plurality of base transceiver stations 104, a packet data serving node (PSTN) 108 to connect the BSC 106 to a packet network, a switch 110 for switching a base station 104 to another base station 104 to which another mobile station 102 belongs, and a base station manager (BSM) 112 to control transmission power of the base station 104 through the base station controller 106.

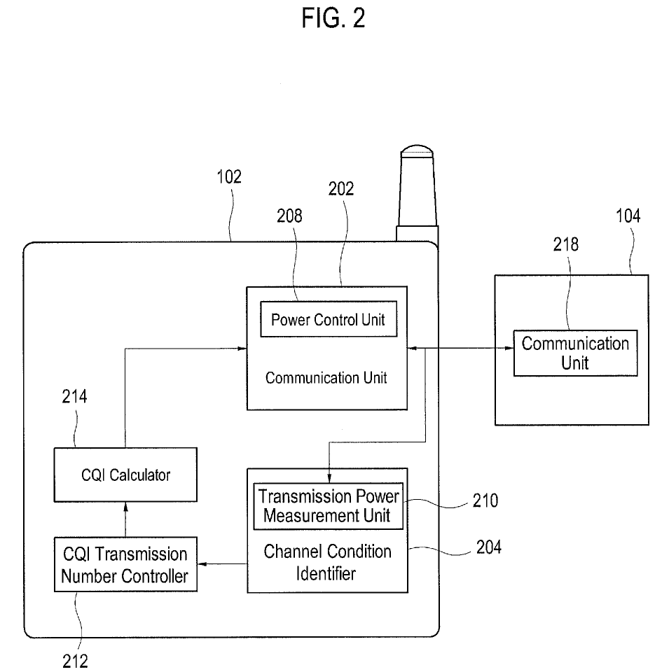

FIG. 2 illustrates a scheme for a mobile station 102 and a base station 104 according to an embodiment of the present invention. According to the embodiment, the mobile station 102 comprises a communication unit 202, a channel condition identifier 204 to identify a channel condition between a mobile station 102 and a base station 104, a CQI (Channel Quality Indicator) transmission number controller 212 and a CQI calculator to calculate a CQI for a communication channel. The communication unit 202 of the mobile station 102 may comprise a power control unit 208 to control the transmission power of a signal to be transmitted to the base station. The channel condition identifier 204 may comprise a transmission power measurement unit 210 to measure the transmission power controlled by the power control unit 208. The base station 104 comprises a communication unit 218 to communicate with the mobile station 102.

Generally, since the mobile station 102 located near the base station 104 can send data to the base station 104 without any errors by using a low transmission power, it does not make much effects on other mobile stations 102 in the same cell or connected to another base station 104. On the contrary, the mobile station 102 located on the border of a cell should transfer data using high transmission power to send information without any errors. Accordingly, it affects other mobile stations 102 in the same cell or connected to another base station 104. In the present embodiment, the transmission power of the mobile station 102 varies according to environments and is automatically controlled by the power control unit 208.

In the present embodiment, the transmission power of the mobile station 102 is measured by the transmission power measurement unit 210 included in the channel condition identifier 204. That is, the channel condition identifier 204 measures the transmission power for data transmitted from the mobile station 102 using the transmission power measurement unit 210 to identify the condition of the channel between the mobile station 102 and the base station 104. Specifically, the channel condition identifier 204 determines that the channel condition is good when the transmission power measured by the transmission power measurement unit 210 is low, while the channel condition is determined to be poor when the measured transmission power is high.

Generally, the mobile station 102 continuously transmits pilot signals to the base station. Since the transmission power of the pilot signals is automatically controlled by the power control unit 208, the transmission power measurement unit 210 may be adapted to measure the transmission power of the pilot signals. This measurement may be performed continuously or at some regular intervals. However, such measurement is not limited on the pilot signals in the present invention. Measurements of transmission power in any channel between the mobile station 102 and the base station 104 may be utilized in the present invention. Further, numerous other modifications can be devised by those skilled in the art that will fall within the spirit of the present invention.

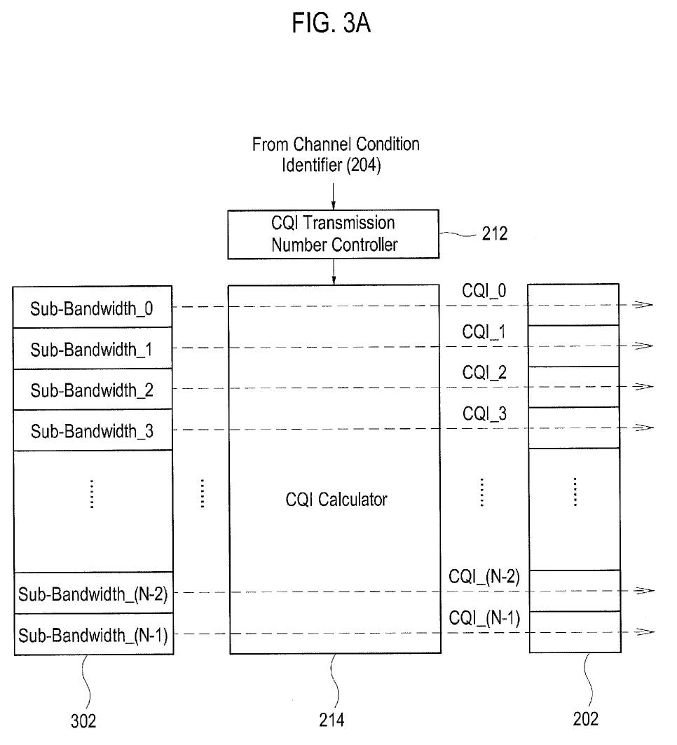

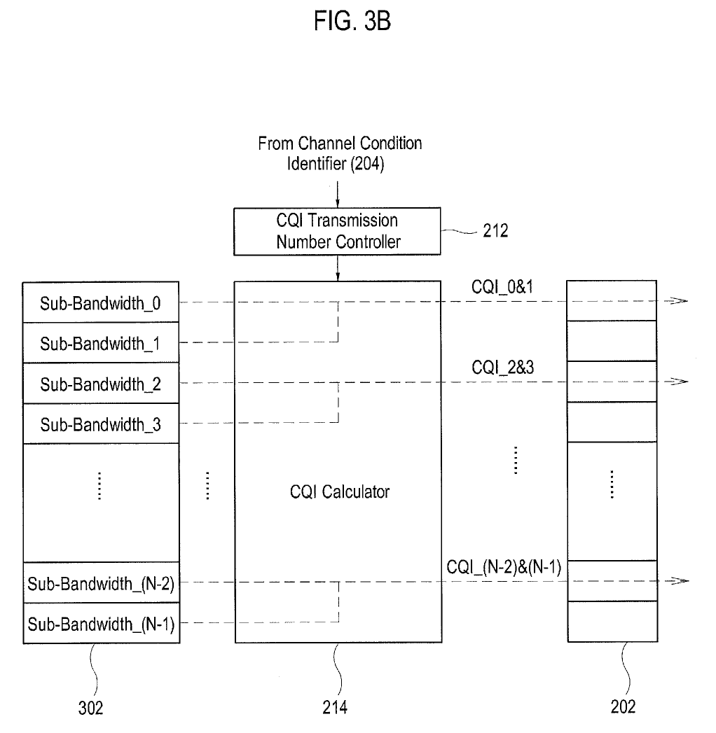

FIGS. 3A and 3B are diagrams illustrating a CQI transmission number controller, a CQI calculator and a communication unit in accordance with a first embodiment of the present invention. The functions of the CQI transmission number controller 212, CQI calculator 214 and communication unit 202 will be explained below in more detail with reference to FIGS. 3A and 3B. The channel condition identified by the channel condition identifier 204 is notified to the CQI transmission number controller 212. The CQI transmission number controller 212 controls the number of CQIs to be transmitted according to the channel condition. For example, when the channel condition is good (i.e., when the mobile station 102 is located near the base station 104), the CQI transmission number controller 102 may transmit as many CQIs as the number of the sub-bandwidths divided from the frequency bandwidth 302 to the base station 104. This case is illustrated in FIG. 3A. As shown in FIG. 3A, if the frequency bandwidth 302 is divided into N pieces, then the CQI transmission number controller 212 adjusts the number of CQIs so that N CQIs may be transmitted and notifies the number to the CQI calculator 214. In response, the CQI calculator 214 calculates a CQI for each of the N sub-bandwidths to produce N CQIs, i.e., CQI_0 through CQI_(N−1). The method to calculate a CQI is well known in the art and thus detailed explanation on said method is omitted herein. These N CQIs are transmitted to the base station 104 by the communication unit 202.

Further, the CQI transmission number controller 212 according to the present embodiment reduces the number of transmitted CQIs as the mobile station 102 moves away from the base station 102. For example, when the transmission power becomes higher than a certain threshold, i.e., when the distance from the base station 104 becomes larger than a predetermined threshold, the CQI transmission number controller 212 reduces the number of CQIs so that N/2 CQIs may be transmitted. This case is illustrated in FIG. 3B. As shown in FIG. 3B, when the CQI transmission number controller 212 notifies the CQI calculator 214 that the number of CQIs has been reduced to N/2, the CQI calculator 214 calculates N/2 CQIs, e.g., by pairing the N sub-bandwidths so that a single CQI may represent the channel condition of two sub-bandwidths. For example, as shown in FIG. 3B, CQI_0&1 is calculated as a value to collectively represent the channel condition of the sub-bandwidth_0 and sub-bandwidth_1. The N/2 CQIs are transmitted to the base station 104 by the communication unit 202. According to the present embodiment, the CQI transmission number controller 212 reduces the number of CQIs as the distance between the mobile station 102 and the base station 104 increases. Finally, it enables the CQI calculation unit 214 to calculate a single CQI for the entire bandwidth in use when the mobile station 102 is on the cell border. On the contrary, when the transmission power becomes lower than a threshold (i.e., when the distance from the base station is shorter than a predetermined threshold), the CQI transmission number controller 212 of the mobile station 102 adjusts the number of the transmitted CQIs.

Hereinafter, a second embodiment of the present invention will be explained with reference to the accompanied drawings. The present embodiment may have the same structures as those of the first embodiment, with the exception of the communication unit 202.

According to the present embodiment, the number of CQIs transmitted from the mobile station 102 varies. That is, the mobile station 102 may transmit N CQIs or one CQI, while the base station may receive N CQIs or one CQIs. Accordingly, since up to N CQIs may be transmitted or received, it is necessary that the mobile station 102 and the base station 104 should have N transmitters and N receivers, respectively.

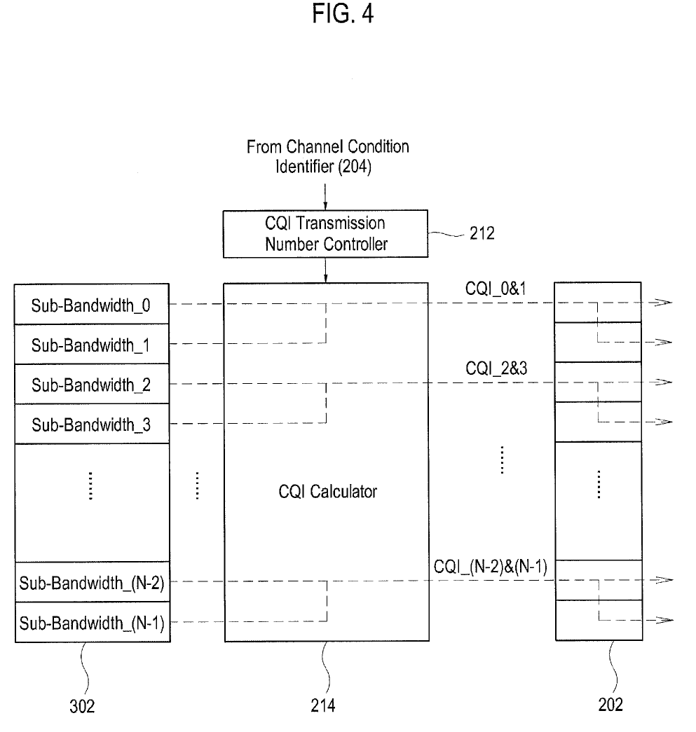

In this regard, the communication unit 202 redundantly transmits identical CQIs as the number of CQIs to be transmitted decreases. For example, as shown in FIG. 4, as the number of CQIs becomes half, each CQI is transmitted twice so that all transmitters and receivers may be fully used to improve the reception quality. Accordingly, when the communication unit 202 redundantly transmits CQIs as the number of CQIs decreases, the actual amount of transmitted data becomes half while the entire data amount is maintained due to such redundant transmission.

According to the present embodiment, since the mobile station 102 transmits identical data redundantly, the transmission power for each transmission may be reduced as the redundancy increases. For example, in the first and second embodiments, the mobile station 102 may transmit N CQIs when it is located near the base station 104, while it may transmit one CQI when it is on the cell border. If the communication unit 202 performs redundant transmission as in the present embodiment, it is possible to transmit a CQI with 1/N of the transmission power with no redundant transmission as in the first embodiment. Further, since identical data are redundantly transmitted, a combination gain may be obtained by combining such data.

In the first and second embodiments, the CQI transmission number controller 212 reduces the number of CQIs to be transmitted as the distance between the mobile station 102 and the base station 104 increases. However, the present invention is not limited to these embodiments. For example, according to the number of sub-bandwidths, the CQI transmission number controller 212 may merge the sub-bandwidths by three. This is so that one CQI value may represent the channel condition of three sub-bandwidths and the number of CQIs to be transmitted may be reduced by ⅓. Further, when using the OFDM method, a frequency bandwidth may be divided into 1024 sub-bandwidths. When there are many sub-bandwidths like the above case, the CQI transmission number controller 212 may reduce the number of CQIs by ¼ or ⅙. Further, numerous other modifications can be devised by those skilled in the art that will fall within the spirit of the present invention.

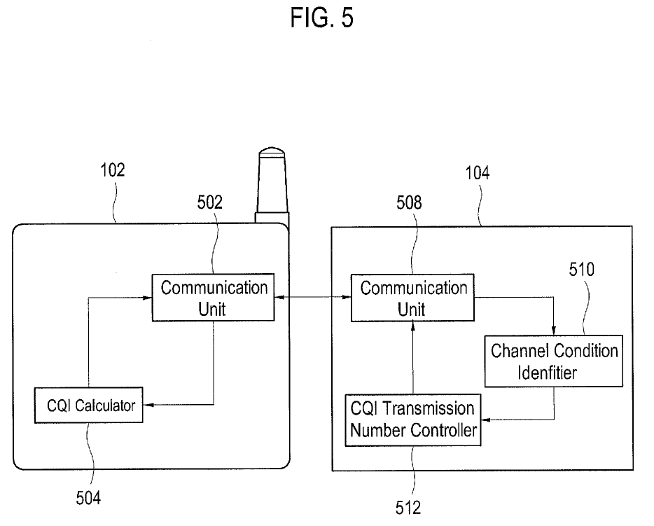

Hereinafter, another embodiment of the present invention will be explained with reference to the accompanied drawings. FIG. 5 illustrates a scheme for a mobile station and a base station. In the present embodiment, the mobile station 102 comprises a communication unit 502 responsible for communication with the base station 104 and a CQI calculator for calculating CQI values associated with communication channels. The base station 104 comprises a communication unit 508 responsible for communication with the mobile station 102, a channel condition identifier 510 for identifying the channel condition between the mobile station 102 and the base station 104, and a CQI transmission number controller 512 to adjust the number of CQIs to be transmitted from the mobile station 102 to the base station 104.

In the present embodiment, the communication unit 502 of the mobile station 102 transmits CQIs values indicating the channel condition to the base station 104. The CQI values transmitted from the mobile station 102 indicate the reception quality of the channel received by the mobile station 102. When the reception quality is low, CQI values are typically set low, and vice-versa. Further, when the mobile station 102 is located closer to the base station 104, the reception quality of the channel received by the mobile station 102 tends to become lower, and vice-versa. The communication unit 508 receives the CQIs transmitted from the mobile station 102 and sends the received CQIs to the channel condition identifier 510. The channel condition identifier 510 identifies the channel condition based on the received CQI values in view of the above tendencies. When one or more CQIs are received, the channel condition identifier 510 averages the received CQI values and identifies the channel condition based on the average CQI value.

The channel condition identifier 510 notifies the identified channel condition to the CQI transmission number controller 512. The CQI transmission number controller 512 adjust the number of CQIs to be transmitted based on the identified channel condition. For example, when the channel condition is identified as being good, the CQI transmission number controller 512 may adjust the transmitted CQI number so that the CQI number equals the number of the sub-bandwidths included in the frequency bandwidth. Further, the CQI transmission number controller 512 may reduce the number of CQIs to be transmitted when the channel condition is identified as becoming poorer.

The number of transmitted CQIs determined by the CQI transmission number controller 512 may be notified to the communication unit 502 of the mobile station 102. The number of CQIs is forwarded from the communication unit 502 to the CQI calculation unit 504. The CQI calculation unit 504 calculates CQIs associated with communication channels as mentioned in the first embodiment and sends the calculated CQIs to the communication unit 502. The communication unit 502 sends these CQIs to the communication unit 508 of the base station 104 as mentioned in the first or second embodiment.

In the present embodiment, when one or more CQIs are received, the channel condition identifier 510 calculates an average of the received CQIs and identifies the channel condition based on the average CQI value. However, the present invention is not limited to this embodiment. For example, a median, a weighted average or a maximum of CQIs, or even the combination of these values, may be also considered. Numerous other modifications can be devised by those skilled in the art that will fall within the spirit of the present invention.

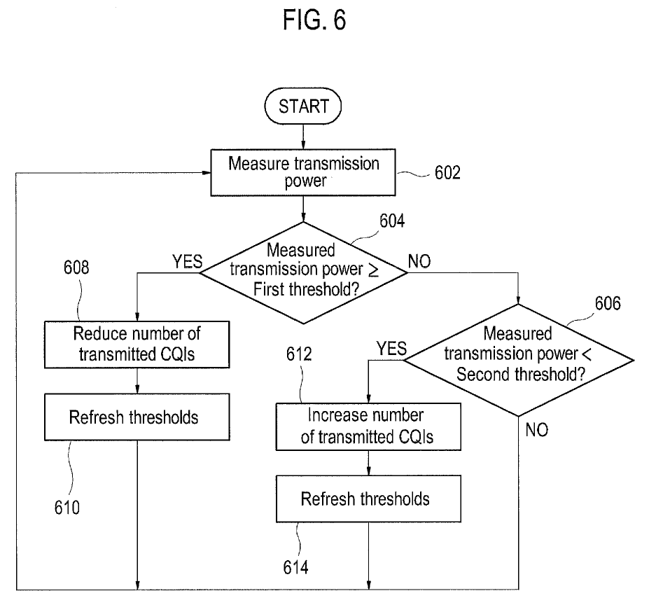

Hereinafter, one embodiment of the present invention will be explained with reference to the accompanied drawings. FIG. 6 is a flow chart illustrating the procedures for determining the change of CQI transmission numbers in a mobile station. As shown in FIG. 6, the procedures begin with the step of measuring the transmission power of pilot signals in the mobile station 102 (602). Then, it is determined whether the measured transmission power is equal to or higher than a first threshold (604). If the transmission power is determined to be equal or higher than the first threshold in the step 604, then the steps of reducing the number of CQIs to be transmitted (608) and refreshing the first threshold and a second threshold (explained later) (610) are performed. Thereafter, the process is returned to the step 602.

If the transmission power is determined to be lower than the first threshold in the step 604, then it is determined whether the transmission power is lower than a second threshold (606). If the transmission power is determined to be lower than the second threshold in the step 604, then the steps of increasing the number of CQIs to be transmitted (612) and refreshing the first threshold and a second threshold (614) are performed. Thereafter, the process is returned to the step 602. The steps 608 and 612 may comprise the step of notifying that the transmission number has changed to the base station 104. If the transmission power is determined to be lower than the first threshold in the step 604 and to be higher than the second threshold in the step 606, then the process is returned to the step of 602 without changing the number of CQIs to be transmitted, the first and second thresholds. The first and second thresholds, which define the threshold range of transmission power, may be changed according to the current number of transmitted CQIs. That is, the threshold range of transmission power may have a certain relationship with the number of transmitted CQIs.

In the present embodiment, the transmission power of pilot signals is continuously measured. However, the present invention is not limited to this embodiment. For example, the transmission power may be measured at certain intervals and the number of CQIs to be transmitted may be determined according to the measured transmission power. Further, in addition to the transmission power of pilot signals, the measurements of the transmission power in any channel between the mobile station 102 and the base station 104 may be utilized in the present invention. Numerous other modifications can be devised by those skilled in the art that will fall within the spirit of the present invention.

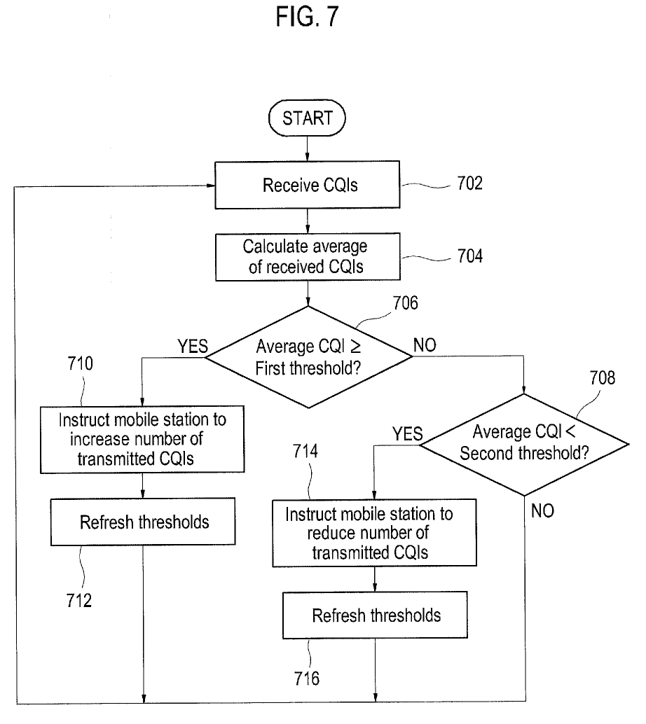

Hereinafter, another embodiment of the present invention will be explained with reference to FIG. 7. FIG. 7 is a flow chart illustrating the procedures to determine the change of CQI transmission numbers in the base station 104. As shown in FIG. 7, the procedures begin with the step of receiving one or more CQIs from the mobile station 102 in the base station 104 (702). Then, the steps of calculating an average of the received CQIs (704) and determining whether the CQI average value is equal to or greater than a first threshold (706) are performed. If the average CQI is determined to be equal to or greater than the first threshold in the step 706, then the steps of instructing the mobile station 102 to increase the number of transmitted CQIs (710) and refreshing the first and second thresholds (explained later) (712) are performed. Thereafter, the process is returned to the step 702.

If the average CQI is determined to be lower than the first threshold in the step 706, then it is determined that the average CQI is lower than a second threshold (708). If the average CQI is determined to be lower than the second threshold in the step 708, then the steps of instructing the mobile station 102 to reduce the number of transmitted CQIs (714) and refreshing the first and second thresholds (716) are performed. Thereafter, the process is returned to the step 702. The steps of instructing the mobile station 102 to change the number of transmitted CQIs (710 and 714) may comprise a step of changing how to process the CQIs received at the base station 104 as the number of transmitted CQIs is changed. If the average CQI is determined to be lower than the first threshold in the step 706 and to be equal or greater than the second threshold in the step 708, then the process is returned to the step 702 without changing the number of CQIs to be transmitted, the first and second thresholds. The first and second thresholds, which are the reference values in changing the number of transmitted CQIs, may be changed according to the current number of transmitted CQIs. That is, the first and second thresholds may have a certain relationship with the number of transmitted CQIs.

In the present embodiment, the base station 104 receives one or more CQIs from the mobile station 102, calculates an average of the received CQIs and refers to the average CQI value. However, the present invention is not limited to this embodiment. For example, a median, a weighted average or a maximum of CQIs, or even the combination of these values, may be also considered.

Further, although the number of transmitted CQIs is changed based on the CQIs received at one time in the present embodiment, the present invention is not limited to this embodiment. For example, the number of transmitted CQIs may be determined based on an average of all CQIs received during a predetermined period, which may suppress excessive increase in the number of communications between the mobile and base stations in accordance with the frequent changes in the CQI transmission number.

Meanwhile, in accordance with one embodiment of the present invention, a mobile station is provided to communicate with a base station in a mobile communication system. The mobile station comprises a channel condition identifier, a CQI transmission number controller, a CQI calculator and a communication unit. The channel condition identifier identifies the channel condition between the mobile station and the base station. The CQI transmission number controller adjusts the number of CQIs to be transmitted to the base station based on the identified channel condition. The CQI calculator calculates the adjusted number of CQIs. The communication unit transmits the calculated CQIs to the base station.

In accordance with another embodiment of the present invention, a base station is provided to communicate with a mobile station in a mobile communication system. The base station comprises a communication unit, a channel condition identifier and a CQI transmission number controller. The channel condition identifier identifies the channel condition between the mobile station and the base station based on one or more CQIs received at the base station. The CQI transmission number controller adjusts the number of CQIs to be transmitted based on the identified channel condition. The communication unit notifies information on the adjusted CQI number to the mobile station.

In accordance with another embodiment of the present invention, a method is provided to transmit one or more CQIs between a mobile station and a base station in a communication system. The method comprises the steps of identifying the channel condition between the mobile and base stations, adjusting the number of CQIs to be transmitted based on the identified channel condition, and transmitting the adjusted number of CQIs.

Any reference in this specification to “one embodiment,” “an embodiment,” “example embodiment,” etc., means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile station for communicating with a base station in a mobile communication system, comprising:
a channel condition identifier for identifying a channel condition between the mobile station and the base station;
a CQI transmission number controller for adjusting a number of one or more channel quality indicators (CQIs) to be transmitted to the base station in accordance with the channel condition;
a CQI calculator for calculating the adjusted number of CQIs; and
a communication unit for transmitting the CQIs to the base station.

2. The mobile station of claim 1, wherein said CQI transmission number controller reduces the number of the transmitted CQIs as the channel condition deteriorates.

3. The mobile station of claim 1, wherein said communication unit determines a degree of CQI transmission redundancy in accordance with the change in the number of the transmitted CQIs and transmits the CQIs based on the degree of CQI transmission redundancy.

4. The mobile station of claim 3, wherein the degree of CQI transmission redundancy is determined so that each of the CQIs is transmitted more than once.

5. The mobile station of claim 1, wherein said channel condition identifier comprises a transmission power measurement unit for measuring the transmission power of the mobile station.

6. The mobile station of claim 5, wherein said transmission power measurement unit is configured to measure the transmission power of pilot channels.

7. The mobile station of claim 5, wherein said transmission power measurement unit is configured to measure the transmission power of CQI channels.

8. A base station for communicating with a mobile station in a mobile communication system, comprising:
a communication unit for receiving one or more CQIs from the mobile station;
a channel condition identifier for identifying a channel condition between the mobile station and the base station based on the CQIs; and
a CQI transmission number controller for adjusting the number of the transmitted CQIs in accordance with the channel condition,
wherein said communication unit notifies information on the adjusted number to the mobile station.

9. The base station of claim 8, wherein said channel condition identifier identifies the channel condition based on an average of the one or more CQIs.

10. The base station of claim 8, wherein said CQI transmission number controller adjusts the number of CQIs to be identical with the number of sub-bandwidths.

11. A method for transmitting one or more CQIs between a mobile station and a base station in a mobile communication system, comprising:
identifying a channel condition between the mobile station and the base station;
adjusting a number of CQIs to be transmitted in accordance with the channel condition; and
transmitting the adjusted number of CQIs.

12. The method of claim 11, wherein the step of adjusting the number of CQIs comprises reducing the number of the transmitted CQIs as the channel condition deteriorates.

13. The method of claim 11, further comprising determining a degree of CQI transmission redundancy in accordance with the change in the number of the transmitted CQIs and the step of transmitting the adjusted number of CQIs comprising transmitting the adjusted number of CQIs based on the degree of CQI transmission redundancy.

14. The method of claim 11, wherein the step of identifying the channel condition comprises identifying the channel condition by measuring the transmission power in the mobile station.

15. The method of claim 14, wherein the transmission power is the transmission power of pilot channels.

16. The method of claim 14, wherein the transmission power is the transmission power of CQI channels.

17. The method of claim 11, further comprising instructing the mobile station to transmit the adjusted number of CQIs.

18. The method of claim 17, wherein the step of identifying the channel condition comprises:
receiving one or more CQIs at the base station; and
identifying the channel condition based on the one or more CQIs.

19. The method of claim 18, wherein the step of identifying the channel condition based on the one or more CQIs comprises:
calculating an average of the one or more CQIs; and
identifying the channel condition based on the average.
